(19) United States
(12) Patent Application Publication
(10) Pub. No.: US 2006/0229886 A1
(43) Pub. Date: Oct. 12, 2006

(54) Method and apparatus for web design layout record delivery

(75) Inventors: Edward Quisenberry, Berkley, MI (US); Stephen S. Womack, St. Louis, MO (US); James L. O'Connor, Greenwood, IN (US); Michael Conover, Greenwood, IN (US); Andrew Foulke, Florissant, MO (US)

Correspondence Address: PAUL S MADAN;MADAN, MOSSMAN & SRIRAM, PC, 2603 AUGUSTA, SUITE 700, HOUSTON, TX, 77057-1130, US

(73) Assignee: SBC Knowledge Ventures L.P., Reno, NV (US)

(21) Appl. No.: 11/092,018

(22) Filed: Mar. 29, 2005

(51) Int. Cl. G06Q 99/00

(52) U.S. Cl. 705/1

(57) ABSTRACT

The present invention presents TIRKS DLRs over a extranet web interface to a user. The DLRs are presented via secure access to the TIRKS system via an intranet. The Web DLR Delivery (WDD) project consists of the DLR facilities of TIRKS, a midrange-hosted application for gathering DLR information and responding to report requests, a data base for storing the DLR and user information, and a secured external (Extranet) web site. WDD automates the DLR delivery process, providing customer service and cost savings to the company. The WDD consists of the DLR facilities of TIRKS, a midrange-hosted application for gathering DLR information and responding to report requests, and an external (Extranet) web site.

### BACKGROUND OF THE INVENTION

1. Field of the Invention

The present invention relates to access of data in a communication network. In particular, the present invention relates to the delivery of design layout records to a customer over a web interface to an extranet associated with a web server passing web pages from a secure intranet.

2. Description of the Related Art

The Trunk Inventory Record Keeping System (TIRKS) is a Telcordia product that is used nationwide to keep track of telecommunication components and circuitry. TIRKS is well known in the art and well documented, see, e.g., Telcordia TIRKS Format Field Directory, Vols. 1-7, reference number: Telcordia Technologies Practice BR 756-551-790 Issue 59, release 20.2, November 2004, which are hereby incorporated by reference in their entirety. TIRKS runs on a standalone computer host and presents various data screens to users describing a telecommunications network. One of the data items available in TIRKS is the Design Layout Record (DLR). In the past the DLR has been delivered via facsimile or US mail. Each of these delivery methods is labor intensive and problematic. Fax numbers can change, fax machines jam. The US mail is slow and expensive. Thus, there is a need for an efficient and fast method of presenting DLRs to a user.

### SUMMARY OF THE INVENTION

The present invention provides set of application program interfaces as well as a method and apparatus that presents TIRKS DLRs over a extranet web interface to a user. The DLRs are presented via secure access to the TIRKS system via an intranet. The present invention provides a Web DLR Delivery (WDD) application that accesses the DLR facilities of TIRKS and provides a midrange-hosted application for gathering DLR information and responding to report requests, provides a data base for storing the DLR and user information, and provides a secured external (Extranet) web site for user access to the DLR. The present invention automates the DLR delivery process, providing customer service and cost savings to DLR delivery.

This present invention receives a batch send of DLRs from TIRKS that are sent periodically via a Network Data Move (NDM). The DLR's are parsed into individual components and TIRKS is queried to define a unique identifier, the Design Routing Code (DRC), for each DLR. The application then scans the DLRs for the IC (customer name), PON (Purchase Order Number), ORD (order number) and any other fields that are of particular interest for selecting or sorting on the web site. The entire DLR, along with the scanned fields, is inserted into an Oracle database.

An extranet web site provides access to DLRs for authenticated customers. Super administrators are established at a Provider site to provide a high level of support to all customers. All passwords are issued by the Provider. Customers select organizational administrators that maintain their user base. Customer users login to a secure web site that offers menu diver DLR selections that allow access to a restricted selection of DLRs. The WDD system is separated into two components, a front end that provides secured customer access and query capabilities to the DLR data and a backend that that receives the DLR data from TIRKS, parses it, assigns a unique index to and stores it in the database.

The DLRs are sent from the 10 Provider regional TIRKS locations in bulk using the Connect:DIRECT Network Data Mover (NDM) and store in flat files on the HP Unix server (chprod37.sbc.com.) Each regional entity has a specific schedule for delivery. The raw DLR data is parsed into individual DLR components. The region of origin is validated and the originating TIRKS is queried to extract a DRC to be used as a unique identifier for the provider customer associated with the DLR.

The Provider Web DLR access of the present invention does not require any special communications beyond access to the internet. All Web DLR interface is designed to be done using Microsoft Internet Explorer Version 6.0, and an Internet connection, broadband or dial-up. Interact in performed by the users addressing the secured web site at the Provider domain, e.g., https://cpcwebdlr@sbc.com.

Examples of certain features of the invention have been summarized here rather broadly in order that the detailed description thereof that follows may be better understood and in order that the contributions they represent to the art may be appreciated. There are, of course, additional features of the invention that will be described hereinafter and which will form the subject of the claims appended hereto.

### BRIEF DESCRIPTION OF THE DRAWINGS

For a detailed understanding of the present invention, references should be made to the following detailed description of an exemplary embodiment, taken in conjunction with the accompanying drawings.

FIG. 1 illustrates a hardware architecture suitable for implementing the present invention;

FIG. 2 is a data flow diagram showing data processing in an example of the present invention;

FIG. 3 is a data flow diagram showing data processing in an example of the present invention;

FIG. 4 is an illustration of raw DLR data formatted for presentation in an example of the present invention;

FIG. 5 is an illustration of data from a TIRKS Design Related Information screen in an example of the present invention;

FIG. 6 is an illustration of data from a TIRKS-TTS screen in an example of the present invention;

FIG. 7 is an illustration of data from a TIRKS-TTS screen in an example of the present invention;

FIG. 8 is an illustration of data from a TIRKS-TTS screen in an example of the present invention;

FIG. 9 is an illustration of data from a TIRKS Design Related Information screen in an example of the present invention;

FIG. 10 is an illustration of data from a TIRKs work authorization screen in an example of the present invention;

FIGS. 11-14 are illustrations of data from a TIRKS-TTS screen in an example of the present invention;

FIG. 15 is an illustration of an Entity Relationship Diagram for storage of DLR related data in a database in an example of the present invention;

FIG. 16 is a data flow diagram for user access to the DLR in an example of the invention; and

FIG. 17-23 are examples of web screens presented in an example of the invention.

### DETAILED DESCRIPTION OF THE INVENTION

In view of the above, the present invention through one or more of its various aspects and/or embodiments is presented to provide one or more advantages, such as those noted below.

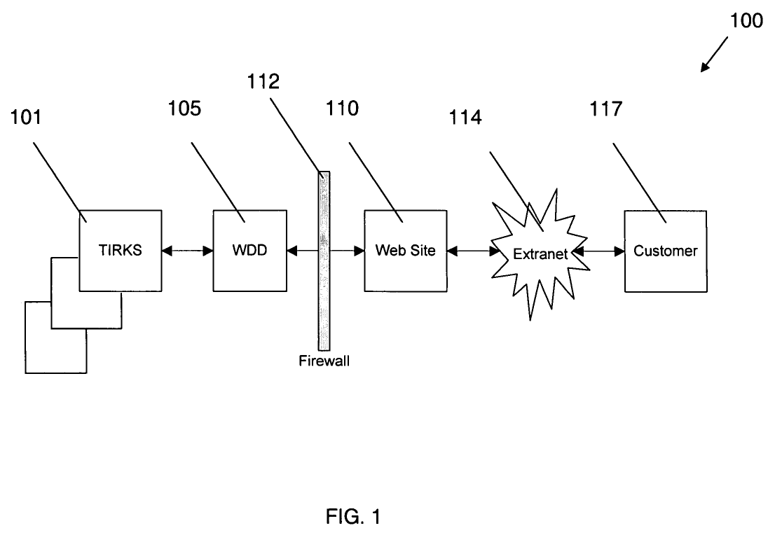

Turning now to FIG. 1 a high level architectural view of the hardware environment in which the present example of the invention resides is presented. The TIRKS resides on a host computer 101 with memory which communicates with the host computer 105 on which a web DLR delivery application (WDD) resides. An intranet firewall 112 exists between the WDD host computer 105 and a web site server 110. A customer 117 can view web pages that access DLR information via an Extranet 114. A network based on TCP/IP protocols (an internet) belonging to an organization, usually a corporation, accessible only by the organization's members, employees, or others with authorization. An intranet's Web sites look and act just like any other Web site, but the firewall surrounding an intranet fends off unauthorized access. Like the Internet itself, intranets are used to share information.

An extranet refers to an intranet that is partially accessible to authorized outsiders. Whereas an intranet resides behind a firewall and is accessible only to people who are members of the same company or organization, an extranet provides various levels of accessibility to outsiders. A customer can access an extranet only if the customer has a valid username and password, and the customer identity determines which parts of the extranet it can view. The host computers maybe for example a Hewlett Packard Model Number HP 9000/800. The WEB DLR Delivery application of the present invention runs on an HP Unix platform. An approximately 190 Gigabyte Oracle database instance is provided for DLR storage on the IPUX platform. A small web page server (e.g, IBM IAX Server, P630 Model 7028) is part of the WDD application and is located on the WDD 105 side of the firewall 112. The small server passes web pages using for example dynamic HTML (e.g., IBM WebSphere™) to present web pages to the customer 117 and receive information from the customer.

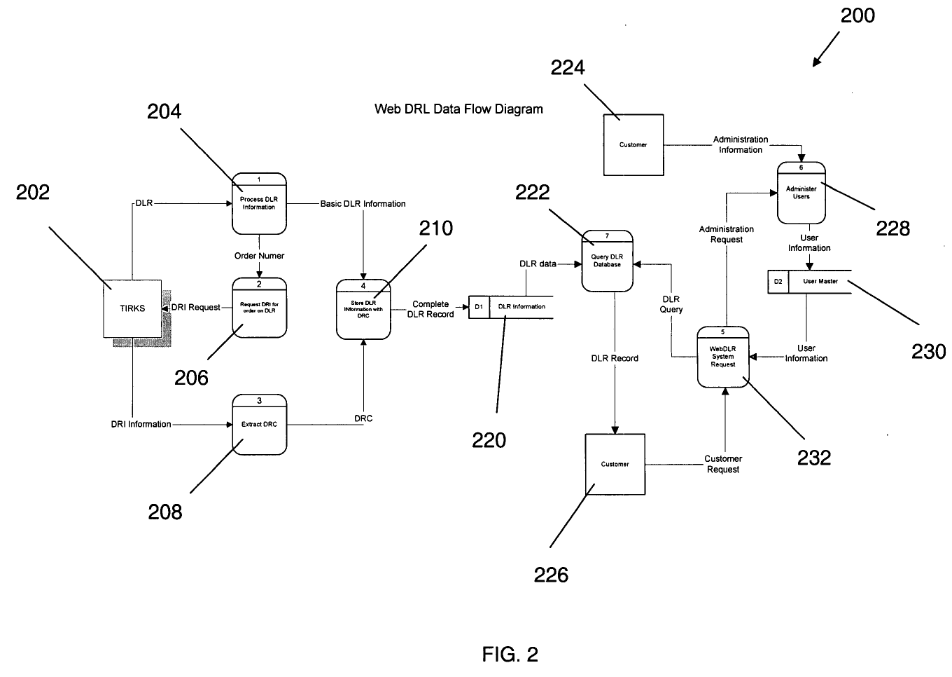

Turning now to FIG. 2 a WebDRL application data flow diagram is presented. The TIRKS host 202 periodically delivers DLR data to process block 204 which processes DLR information. Process block 206 requests DRI screen data from TIRKS 202. The DRI screen data (DRI information) is sent from TIRKS to process block 208 which extracts the Design Routing Code (DRC) from the DRI information. The DLR information is then stored in along with the DLR information in process block 210. The complete DLR Record containing the identifying DRC is then parsed and stored in a relational data base 220. A customer 226 subsequently sends customer request to process block 232 WebDRL System Request. If the customer request is to view DLR information, a DLR query is sent to process block 222 which then queries the data base to retrieve DLR data for the customer. If the customer request is an administration request, block 232 sends an administration request to bock 228 which handles administration of users. A customer 224 can then enter customer information setting up user accounts. The user information is entered into the user master data base 230. This user information is used in process block 232 to authenticate users and to provide direction on DLR access.

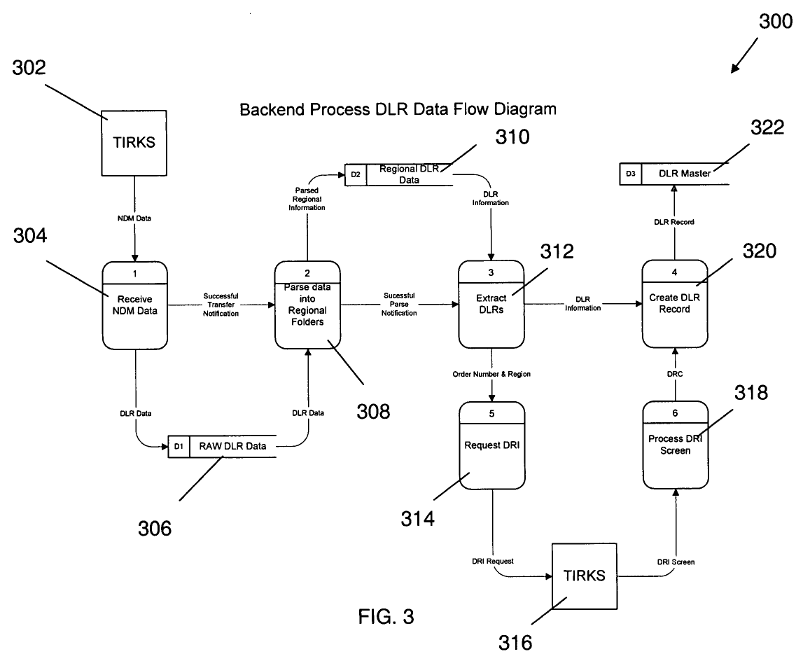

Turning now to FIG. 3, a Data Flow Diagram for the processing TIRKS data for presentation to a user, the “backend” is presented. (User access discussed later is referred to as the “front end”). The TIRKS system, shown as 302 in FIG. 3 periodically sends raw DLR data via a network data move (NDM) to block 304. The NDM is scheduled or “CRON'd” (or a clock set) on the TIRKS host 302 to send raw batched DLR data to the WDD application at set time periods, for example 1,2,3,4 and 5 pm daily. The WDD application is likewise scheduled or “CRON'd” to process each batch of DLR data at set time periods, for example, 1:30, 2:30, 3:30, 4:30 and 5:30 pm daily repectively. In process block 304, the present invention thus receives the raw DLR data as NDM data. Upon successful receipt of the NDM of DLR data, process block 304 sends a successful transfer notification to process block 308. Process block 308 then parses the raw DLR data 306 into regional folders. Upon successful parsing of the DLR data process block 308 sends a successful parse notification to process block 312. Upon receipt of the successful parse notification, process block 312 extracts appropriate DLRs from the parsed regional information stored in the Regional DLR data 310.

Upon successful extraction of the DLRs process block 312 sends DLR information to block 320 and block 320 creates a DLR record. Process block 312 also extracts an order number and region from the raw or parsed DLR data. Process block 314 then sends the order number and region to TIRKS 316 to request DRI screen data. TIRKS 316 sends the DRI screen data to block 318 which processes the DRI screen data to determine a DRC for the DLR. Process block 320 adds the DRC to the DLR information from process block 312 and creates a DLR record. Process block 320 then stores the DLR record in the DLR master at process block 322.

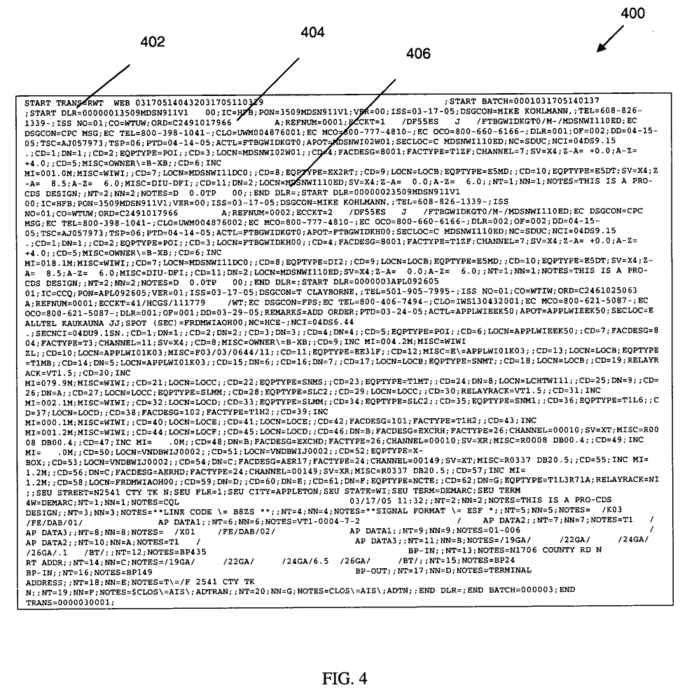

Turning now to FIG. 4 the raw DLR data is illustrated in process block 400. The raw DLR data has been formatted into process block 400 for purposes of illustration, however, the raw DLR data is received a long character string without carriage returns or formatting. A START DLR indicator 400 and END DLR indicator 406 are embedded in the raw DLR data to indicate the beginning and end of each DLR record in the raw DLR data. The DLR includes tags and tag values that are used to parse the DLR and store it in a relational database for searching on the associated tags. One example of a tag is an order number “ORD” 404 which has a value of C2491017966 and is embedded in the DLR record. The order number value is used to query TIRKS to obtain a unique identifier for the customer. To do this the Design Related Information (DRI) screen is requested using the order number obtained from the DLR.

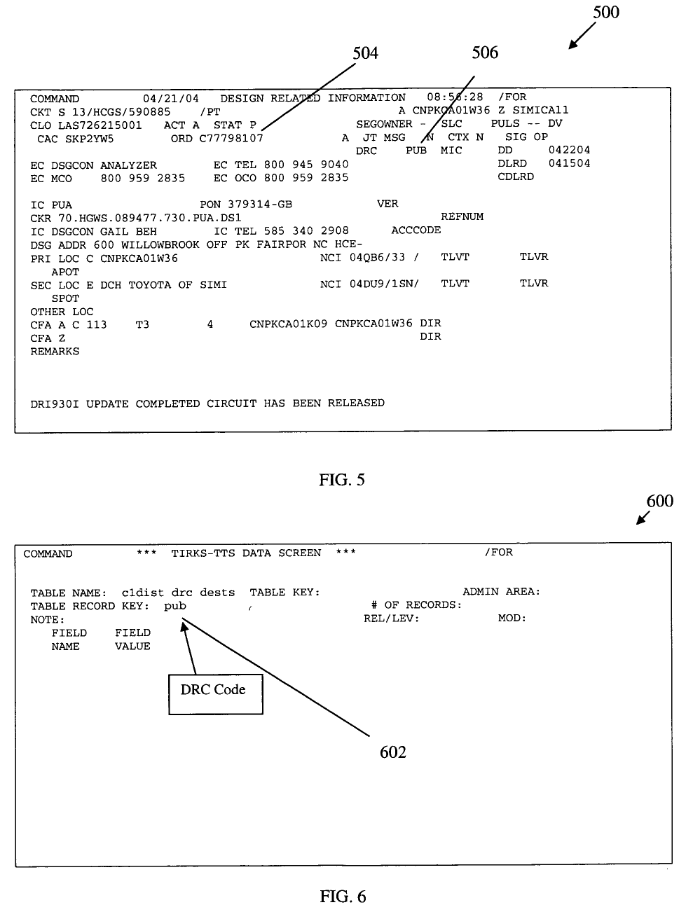

Turning now to FIG. 5, the present invention sends the order number to TIRKS requesting screen data for an associated Design Related Information (DRI) screen. In this case the order number 504 has an associated DRC code which in this case is “PUB”. Turning now to FIG. 6, the DRC code can be validated or cross-checked to avoid TIRKS data base errors by checking the DRC code from the DRI screen data 500 against the DRC code 602 in the TIRKS-TTS data screen data 600. In this case the C1DIST DRC DESTS table 600 is reviewed to assure DRC validity. Tables are requested using the DRC extracted from the DRI.

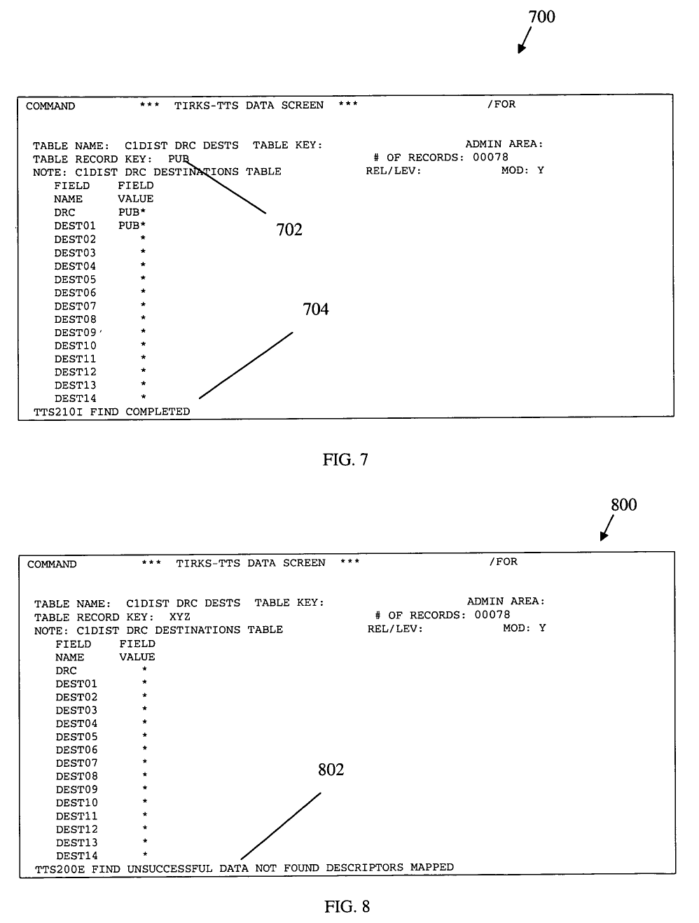

To validate the DRC, the present invention issues a TIRKS find (F1) command to TIRKS on the DRC. As shown in FIG. 7, if the DRC is valid for the DRC, when the DRC is used as the Table Record Key 702, a “Find Completed” 704 is returned. Turning now to FIG. 8, if the DRC when used as the Table Record Key 802 is not valid in the specific TIRKS data base, a “Find Unsuccessful” message 802 will be returned.

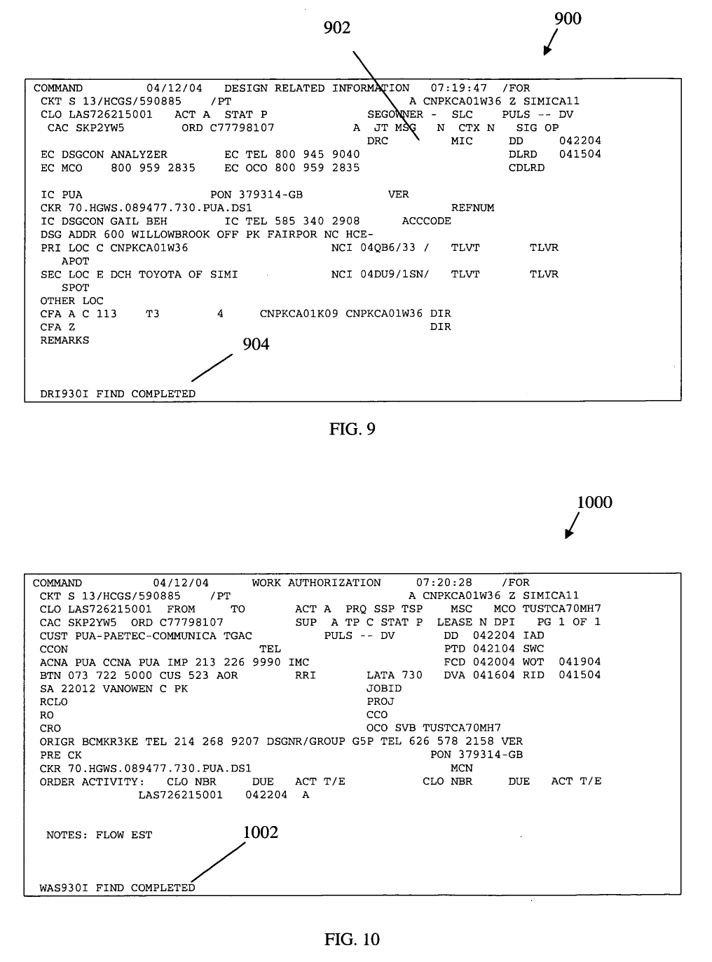

Turning now to FIG. 9, DRC codes are not automatically loaded into all of the TIRKS databases. The customer tells the provider the regions for which they want to receive DLRs, and only those TIRKS databases are updated. A DRC is valid in the one regional provider TIRKS database and may not be valid in any other provider TIRKS database. When a DRC code is left blank, that is, unpopulated as shown in FIG. 9 at 902, the present invention queries TIRKS to go to the TTS tables to see if it can find a match for the CNA (ACNA or CCNA) codes used on the order. As shown in FIG. 10, the CNA (ACNA/CCNA) codes are used on the order can be seen on or extracted from the data that makes up the WA screen. The TIRKS screens are requested by the present invention from TIRKS for various inquiries. TIRKS goes to the C1PREP DRC DEFLT table to see if the customer's ACNA/CCNA combination is built into the table.

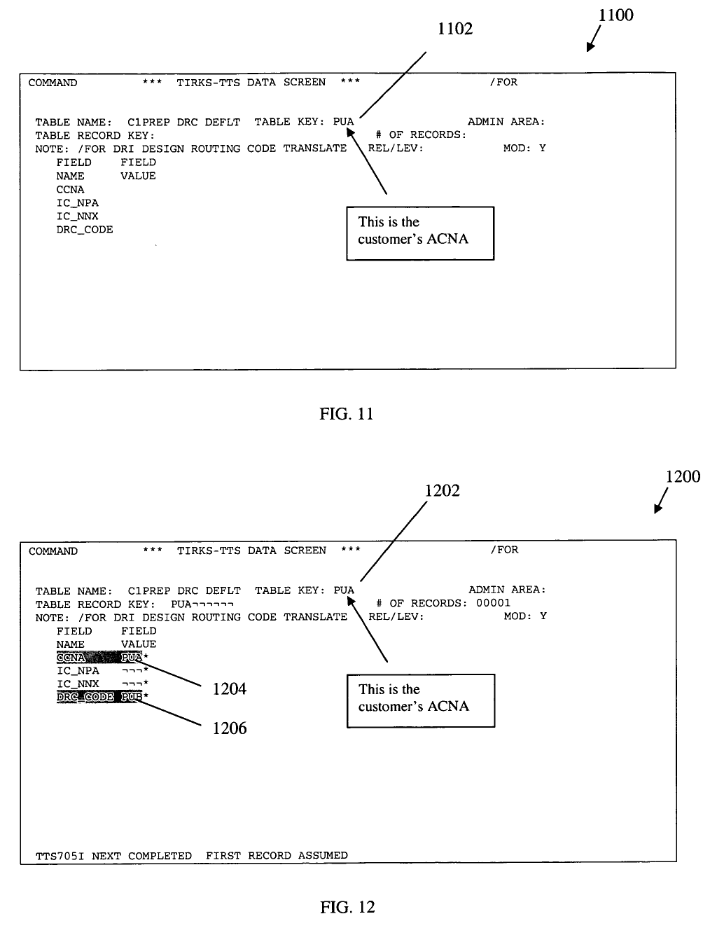

As shown in FIG. 11, the customer's ACNA is used on this screen. The present invention issues a Next (F6) to TIRKS to search for the DRC. In this case the ACNA is PUA 1102. If it's found, a “Next Completed” message will be returned. TIRKS will know which DRC code to use with the ACNA/CCNA combination. In this case, the CCNA 1204 is PUA and DRC code 1206 that should have been used on the order was PUB.

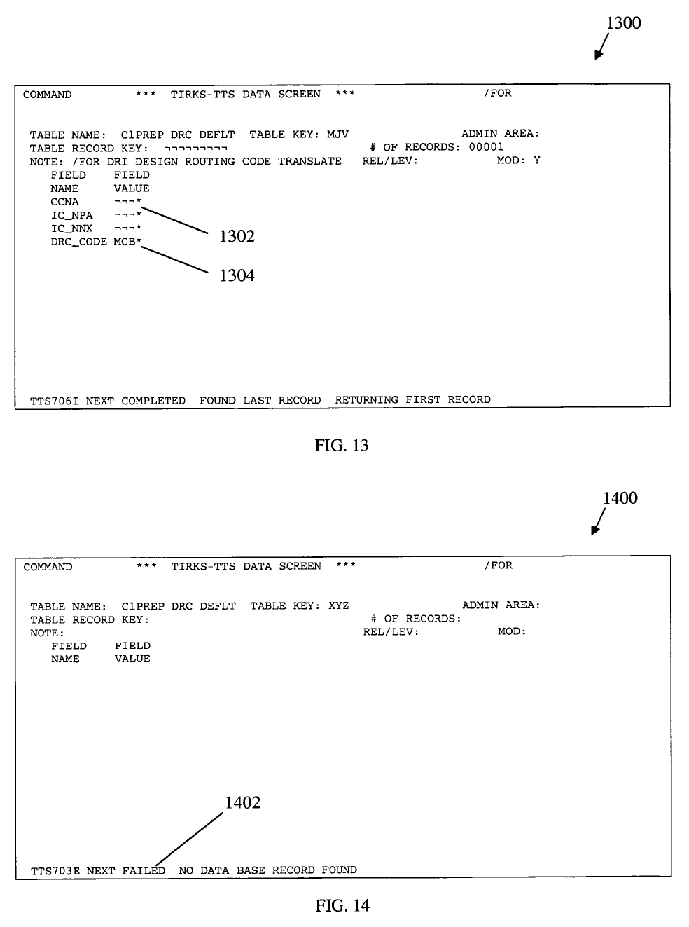

As shown in FIG. 13, the ACNA can be used with multiple CCNAs, and the CCNA can also be a wildcard 1302 in the tables, whereby the ACNA can be used with any CCNA. FIG. 13 item 1302 is an example of how the wildcard can be used in the CCNA field. As shown in FIG. 14, if the ACNA/CCNA combination is not built into the tables, a “NEXT FAILED” message 1402 will be returned from TIRKS. CNA (ACNA/CCNA) combinations are not automatically loaded into all of the TIRKS databases. Customers requesting a DLR have the DRC code and associated ACNA/CCNA combinations updated only in those TIRKS databases. Once the DRC has been extracted from the appropriate TIRKS location, the DRC is used in conjunction with the order number to provide the unique customer identifier for storage in the database. The DLR is stored in the database, such as an Oracle database.

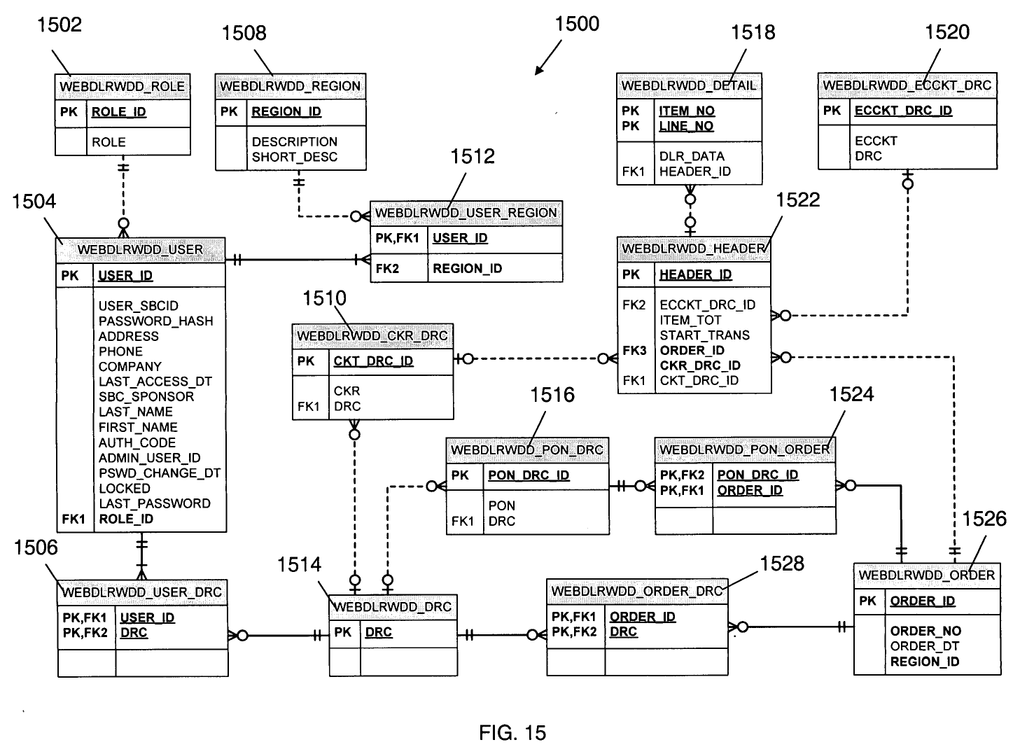

As shown in FIG. 15, an Oracle™ database standard entity relationship diagram 1500 defining the relationships between entities 1502-1528 as stored in the relational data base, in this case an Oracle Database. An entity relationship diagram is also called an entity-relationship model, a graphical representation of entities and their relationships to each other, typically used in computing in regard to the organization of data within databases or information systems. An entity is a piece of data—an object or concept about which data is stored. A relationship is how the data is shared between entities. There are three types of relationships between entities: One-to-one: one instance of an entity (A) is associated with one other instance of another entity (B). For example, in a database of employees, each employee name (A) is associated with only one social security number (B). One-to-many: one instance of an entity (A) is associated with zero, one or many instances of another entity (B), but for one instance of entity B there is only one instance of entity A. For example, for a company with all employees working in one building, the building name (A) is associated with many different employees (B), but those employees all share the same singular association with entity A. Many-to-many: one instance of an entity (A) is associated with one, zero or many instances of another entity (B), and one instance of entity B is associated with one, zero or many instances of entity A. For example, for a company in which all of its employees work on multiple projects, each instance of an employee (A) is associated with many instances of a project (B), and at the same time, each instance of a project (B) has multiple employees (A) associated with it.

The entity relationship diagram of FIG. 15 is an Oracle standard Entity Relationship Diagram well know in the art and well documented by Oracle Corporation of Redwood Shores, Calif. The DLR and User Id data are stored in the database and related as shown in FIG. 15. The entities are populated with the DLR related values (1506, 1510, 1514, 1516, 1518, 1520, 1522, 1524, 1526 and 1528) and the User Identifier values (1502, 1504, 1506, 1508 and 1512). As shown in FIG. 15, the Role Id is defined and stored in WEBDLRWDD_ROLE 1502. The User Id is defined between WEBDLRWDD_ROLE 1504 (USER_SBCID, PASSWORD_HASH, ADDRESS, PHONE, COMPANY, LAST_ACCESS_DT, SBC_SPONSOR, LAST_NAME, FIRST_NAME, AUTHO_CODE, ADMIN_USER_ID, PASWD_CHANGE_DT, LOCKED, LAST_PASSWORD). The User Id to Region relationships are defined between WEBDLRWDD_USER_REGION 1512 and WEBDLRWDD_REGION 1508.

WEBDLRWDD_USER_DRC 1506 defines the relationship between the USER_ID and DRC. The WEBDLRWDD_DRC 1514 defines the relationship between the DRC and CK_DRC_ID 1510, PON_DRC_ID 1516 AND ORDER_ID 1528. WEBDLRWEE_HEADER holds the HEADER_ID. WEBDLRWDD_DETAIL HOLDS DLR_DATA which is the sorted DLR for the customer having a particular unique customer identifier or USER_ID.

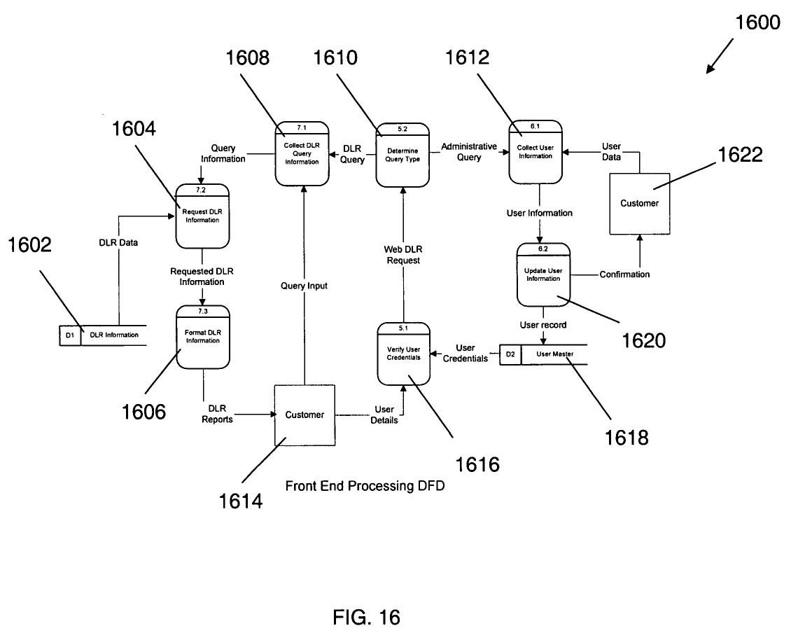

Turning now to FIG. 16, a data flow diagram 1600 is presented illustrating the process of accepting user requests and presenting data to a user (Front End Processing). As shown in FIG. 16, a customer 1614 may input a query to process block 1608. Process block 1608 formulates a query into the DLR master by collecting DLR query information comprising the unique customer identifier, regions, customer name, order number and DRC. The DLR master data base can be searched by CKR, ECC or PON to find a DLR associated with a CKR, ECC or PON, as shown in the Entity Relationship Diagram of FIG. 15. This query information is submitted to process block 1604 which extracts the requested DLR information from the DLR master database 1602. The requested DLR information is returned to process block 1604 and sent to process block 1606 where the DLR information is formatted and sent to the server outside of the firewall for presentation to the customer 1614.

The customer may also enter user details such as information for an existing user account may be verified at process block 1616. Process block 1616 may access user credentials from the user master 1618 database to authenticate the user. Once authenticated the user may make a Web DLR Request to process block 1610. Process block 1610 determines the query type, formulates the query and sends it to process block 1608 to collect the DLR Query information. Process block 1608 then sends query information to process block 1604 as described above. A customer may also enter user data described below to process block 1612 which collects the user information and sends it to process block 1620. Process block 1620 then updates the user information and confirms the user information with the user. The user data is stored as a user record in the user master database 1618.

To understand the workings of the present invention an example is presented as a WebDLR web interface (henceforth, web). In this example, it is helpful to understand the roles that a user might play. The roles are broken into two categories—provider personnel and non-provider personnel. The non-provider personnel are customers who work for affilitates—they are not provider employees, but work for other companies. These other companies are WebDLR customers.

A user of the WebDLR may have one and only one role. The roles, from most to least restrictive in system access, are User, Administrator, and Super Administrator

User—for non-provider personnel only, this role is a customer for viewing DLRs. In the example, “User” refers to a role. The lower case “user” may refer to User, Administrator, Super Administrator or Developer. Administrator—for customer personnel only, this role is for administering Users. Super Administrator—, this role is for administering Administrators, and monitoring Administrators and Users.

Developer—this role is for administering Super Administrators, but also has complete access to the web system. The web pages that are displayed to a user depend on the role the user has in the system.

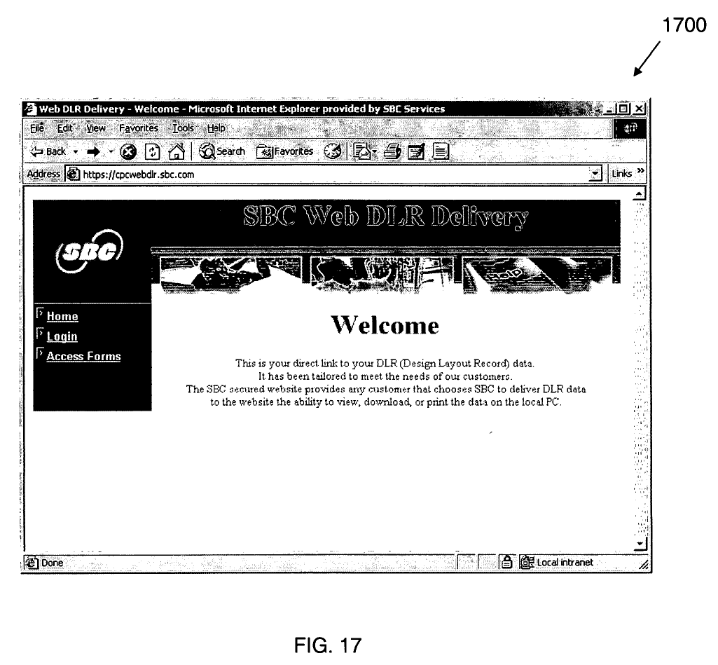

A welcome screen 1700 for the WEB DLR Delivery application used as an example of the present invention is shown in FIG. 17. To gain access to the web, a user must have a login and a password. This login is their email address. A users' password is sent to him/her, via email, when his/her profile is created by his/her superior. The first time the user logs in, he/she can change the password to something they prefer, but have to have the generated password to get access to do this. This email also contains an AUTH CODE. The user must provide this AUTH CODE any time they want their supervisor to reset his/her password.

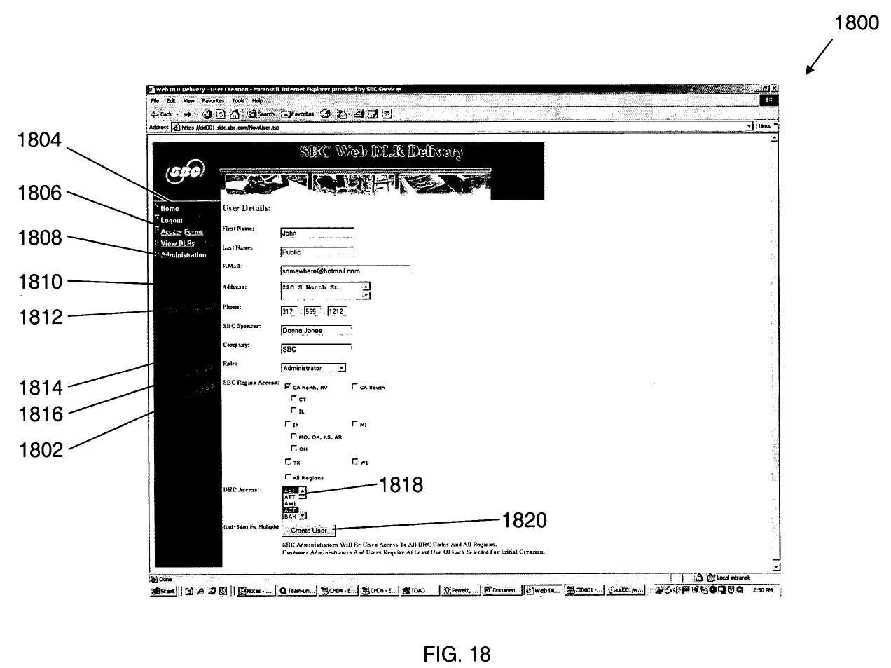

To get access to the WebDLR web interface, a user has to be created. This is done by the role that is higher than the user being created. For instance, a User is created by an Administrator, an Administrator is created by an SBC Administrator and so on. FIG. 18 is an example of the web page to create a User. The user enters user details such as first name 1804, last name 1806, email address 1808, physical address 1810, phone number 1812, company name 1814, role 1816 and region 1802 and DRC access 1818. As can be seen from the web page, a user is given access to at least one region and one DRC. When the Create User button 1820 is pushed, an email is sent to the E-Mail address designated on the web page. This email contains the new user password. His/Her login is their E-Mail address. This email also contains an auth code. This auth code is provided by the user when they want their password reset. Once the user is created and receives their email, he can log in. Once he gets to the site, he will be prompted for a password he would like to use, rather than the one emailed to him.

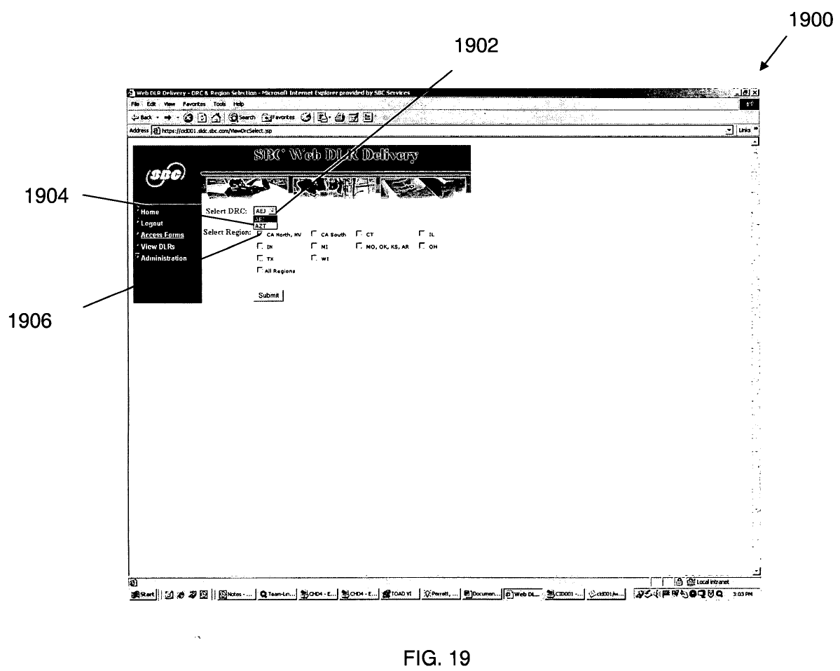

As shown in FIG. 19, in this web page, this new user can only access DRCs of AEJ 1902 and AZT 1904, those which were selected for him at user creation. He can only see the CA North, NV region 1906 which was also selected for him at user creation. Also, since no subordinates have been created for this user yet, by clicking on the Administration link, we can see that there are none to display (represented by the horizontal gray lines on the web page). All the new user can do at this point is create a User, by clicking on the Create User button. As can be seen, the only role this new user can create is a User. This is because this user was created as an Administrator, and the only role subordinate to an Administrator is User.

The DLR (Design Layout Record) provides the Access Customer with essential design information required to turn up service in all regions. Much of the administrative and technical specifications for the DLR are derived from the Access Customer Request (ACR) which is provided by the Access Customer. If the Access Customer doesn't waive the DLR, the DLR document (DLRD) is initiated and provided at issuance of the Word Document on RID (Record Issuance Date). When the user is created and receives their email, he can now begin logging into the Web DLR internet site. Upon accessing the site, users will be prompted for a new password. Once this is entered, the user will receive the following web page. After selecting the View DLRs link, the user can then select their desired search parameters. User DRC scope and range is defined at the time of the user account creation.

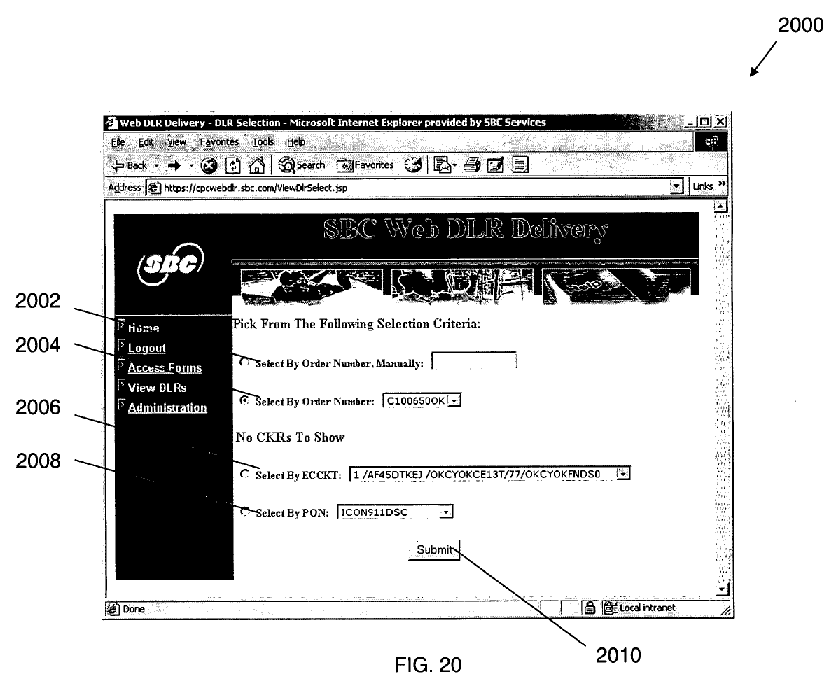

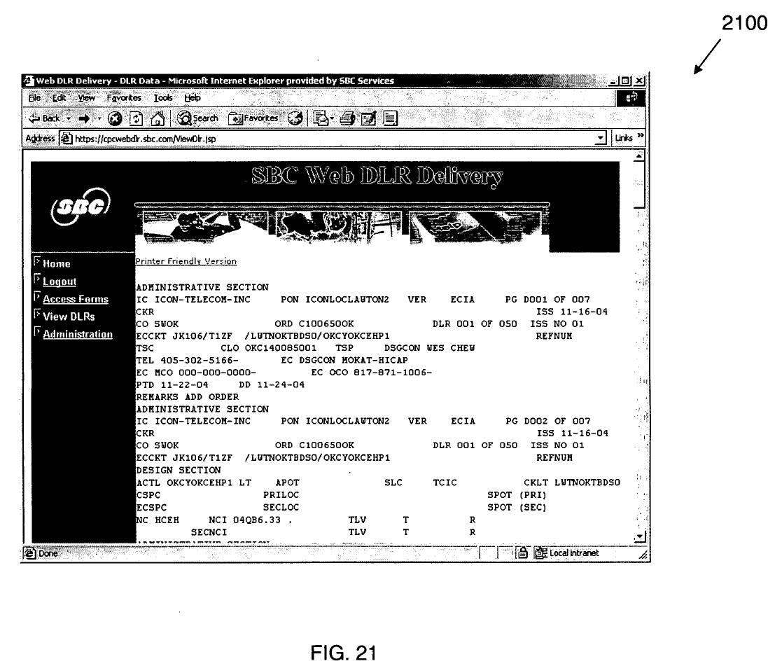

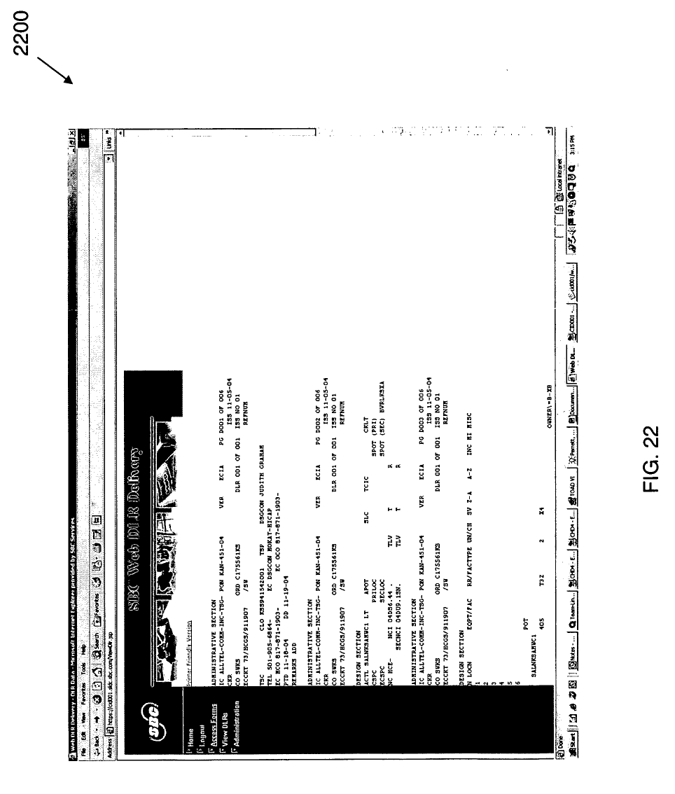

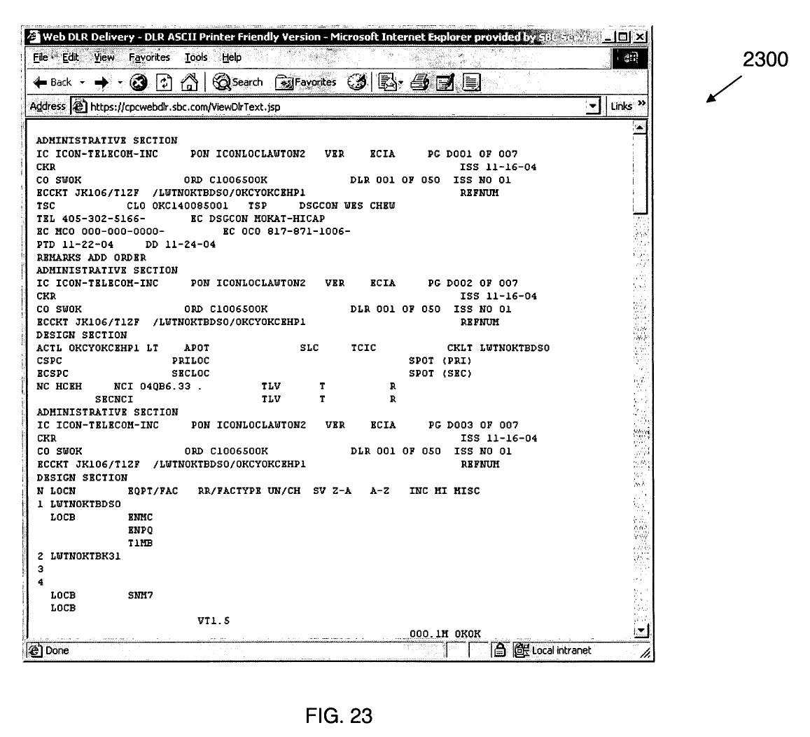

As shown in FIG. 20, Users are provided with several search choices. The choices are detailed in the web screen 2000. The selection criteria: order number manually 2002, order number list 2004, select by ECCKT 2006 and select by Purchase Order Number (PON) 2008 are determined and the “Submit” virtual button is selected. The DLR meeting the criteria is returned to the user. A formatted DLR presentation screen 2100 is shown in FIG. 21. As shown in FIGS. 22 and 23 Users can select a printer friendly version duplicated the format of the traditional DLR.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the invention in its aspects. Although the invention has been described with reference to particular means, materials and embodiments, the invention is not intended to be limited to the particulars disclosed; rather, the invention extends to all functionally equivalent structures, methods, and uses such as are within the scope of the appended claims.

In accordance with various embodiments of the present invention, the methods described herein are intended for operation as software programs running on a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present invention as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. Accordingly, the invention is considered to include a tangible storage medium or distribution medium, as listed herein and including art-recognized equivalents and successor media, in which the software implementations herein are stored.

Although the present specification describes components and functions implemented in the embodiments with reference to particular standards and protocols, the invention is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

What is claimed is:

1. A computerized method for presenting a web page for a design layout record (DLR) to a customer comprising:
accepting a DLR from a trunk information record keeping system (TIRKS);
associating the DLR with a unique customer number; and
presenting the web page for the DLR to the customer.

2. The method of claim 1, wherein associating further comprises extracting an order number from the DLR and querying the TIRKS for a design routing code (DRC) associated with the order number to form the unique customer number.

3. The method of claim 2, further comprising:
validating the DRC in the TIRKS.

4. The method of claim 1, wherein associating further comprises:
extracting an order number from the DLR and querying the TIRKS for a CNA associated with the order number.

5. The method of claim 4, further comprising:
extracting a DRC from the TIRKS response to the query to form the unique customer number.

6. The method of claim 1, further comprising:
storing the DLR with the unique customer identifier in a database.

7. The method of claim 1, further comprising:
accepting the unique customer from the customer; and
accessing the DLR based on the unique customer number.

8. The method of claim 1, wherein the webpage is presented from an intranet over an extranet.

9. A computer readable medium containing instructions that when executed by a computer computerized method for presenting a web page for a design layout record (DLR) to a customer comprising:
accepting a DLR from a trunk information record keeping system (TIRKS);
associating the DLR with a unique customer number; and
presenting the web page for the DLR to the customer.

10. The medium of claim 9, wherein in the method associating further comprises extracting an order number from the DLR and querying the TIRKS for a design routing code (DRC) associated with the order number to form the unique customer number.

11. The medium of claim 10, the method further comprising:
validating the DRC in the TIRKS.

12. The medium of claim 9, wherein in the method associating further comprises:
extracting an order number from the DLR and querying the TIRKS for a CNA associated with the order number.

13. The medium of claim 12, the method further comprising:
extracting a DRC from the TIRKS response to the query to form the unique customer number.

14. The medium of claim 9, the method further comprising:
storing the DLR with the unique customer identifier in a database.

15. The medium of claim 9, the method further comprising:
accepting the unique customer from the customer; and
accessing the DLR based on the unique customer number.

16. The medium of claim 9, wherein in the method the webpage is presented from an intranet over an extranet.

17. A set of application program interfaces embodied on a computer readable medium for execution on a computer in conjunction with an application program that presents a webpage for a design layout record (DLR) to a customer over an extranet, comprising:
a first interface that receives a DLR from a trunk inventory and record keeping system (TIRKS);
a second interface that receives a request from the customer; and
a third interface that receives web page for display to the customer over the extranet.

18. The set of application program interfaces of claim 17, further comprising:
a fourth interface the receives a request from the customer to display the DLR.

19. The set of application program interfaces of claim 17, further comprising:
a fourth interface that receives a response from a TIRKS query for a unique customer number.

20. The set of application program interfaces of claim 17, further comprising:
a fourth interface that receives a parsed DLR and unique customer number for storage in a data base.
